(19) United States
(12) Patent Application Publication
(10) Pub. No.: US 2008/0033851 A1
(43) Pub. Date: Feb. 7, 2008

(54) METHODS AND APPLICATION FOR MANAGING INVOICES

(76) Inventors: Joshua M. Williams, North Richland Hills, TX (US); Scott D. Raymond, Kansas City, KS (US)

Correspondence Address: CARR LLP, 670 FOUNDERS SQUARE, 900 JACKSON STREET, DALLAS, TX, 75202, US

(21) Appl. No.: 11/775,093

(22) Filed: Jul. 9, 2007

Related U.S. Application Data
(60) Provisional application No. 60/833,017, filed on Jul. 25, 2006.

(51) Int. Cl. G07F 19/00

(52) U.S. Cl. 705/34

(57) ABSTRACT

The present invention provides methods and systems for creating, distributing, and managing invoices.

### CROSS-REFERENCED APPLICATIONS

This application relates to, and claims the benefit of the filing date of, co-pending U.S. provisional patent application Ser. No. 60/833,017 entitled METHODS AND APPLICATION FOR MANAGING INVOICES, filed Jul. 25, 2006, the entire contents of which are incorporated herein by reference for all purposes.

### FIELD OF THE INVENTION

The invention relates generally to invoicing systems and, more particularly, to automated invoicing systems using wide area networks to exchange invoicing information.

### BACKGROUND

All businesses rely on some method of invoicing their customers for products delivered, services performed, or various combinations of the two. Generally, the customer pays the vendor of the products or services only after receiving an invoice. Thus, it would be beneficial if, among other things, an efficient method of speeding the creation and distribution of invoices could be provided.

### SUMMARY

The present invention provides methods and systems for creating, distributing, and managing invoices.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an invoicing system constructed in accordance with the principles of the present invention.

FIG. 2 illustrates a method of creating an invoice in accordance with the principles of the present invention.

FIG. 3 illustrates a method of creating a periodic invoice template in accordance with the principles of the present invention.

FIG. 4 illustrates another invoicing system constructed in accordance with the principles of the present invention.

FIG. 5 illustrates another method of invoicing in accordance with the principles of the present invention.

FIG. 6 illustrates a method of commenting on invoices in accordance with the principles of the present invention.

FIG. 7 illustrates an application program interface (API) constructed in accordance with the principles of the present invention.

FIG. 8 illustrates a method of converting e-mail messages to invoices in accordance with the principles of the present invention.

FIG. 9 illustrates a method of translating invoices between languages in accordance with the principles of the present invention.

FIG. 10 illustrates a filtered ledger constructed in accordance with the principles of the present invention.

FIG. 11 illustrates another filtered ledger constructed in accordance with the principles of the present invention.

FIG. 12 illustrates yet another filtered ledger constructed in accordance with the principles of the present invention.

FIG. 13 illustrates still another filtered ledger constructed in accordance with the principles of the present invention.

FIG. 14 illustrates a ledger with an interface for adding and deleting tags to invoices constructed in accordance with the principles of the present invention.

FIG. 15 illustrates filtered ledger constructed in accordance with the principles of the present invention.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

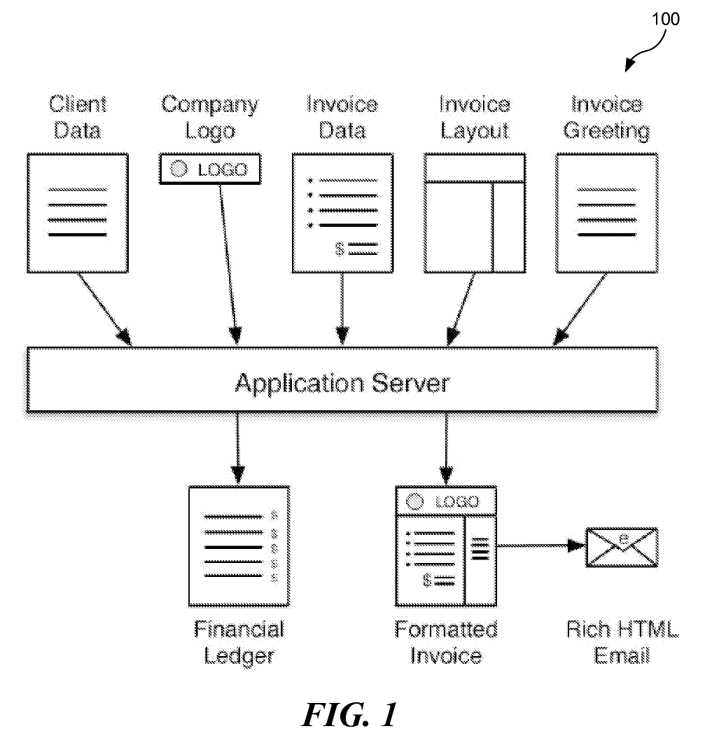

Referring to FIG. 1 of the drawings, the reference numeral 100 generally designates a system embodying features of the present invention. More particularly, FIG. 1 shows that, among other things, client data and invoice data can be linked to a server. The server may include a database that contains the client and invoice data so that, for example, the server can create ledgers and add information thereto. The server may use a uniform resource locator (URL) address contained in an e-mail message to link the invoice to the ledger via the database. Once a link between a particular customer's first invoice and a particular vendor's ledger is created, future invoices from that vendor to that customer may automatically be added to the database and, hence, the ledger. Regarding the invoices, FIG. 1 also illustrates that Cascading Style Sheets may be used with the invoice creation e-mail message to specify the format of the invoice.

In the embodiment illustrated in FIG. 1, using a web-based interface, a user enters data about a client (name, address, contacts, etc.), and invoice data (quantities, descriptions, fee schedule, etc.). That information is merged with a design template (specified in cascading style sheets format) and a company logo (in GIF, JPEG, BMP, SVG, or TIFF format). Summaries of invoice information are automatically reflected in the user's financial ledger. The service automatically applies late fees and updates the financial ledger appropriately. The service processes and sends invoices as a rich HTML e-mail. The user enters client and invoice data into the service, including invoice layout, template and client logo. The service provides the financial ledger with a summary of the invoice data. The service merges invoice data with an invoice layout, client data, a client logo, and an invoice greeting to create a formatted invoice, and delivers it as rich HTML e-mail.

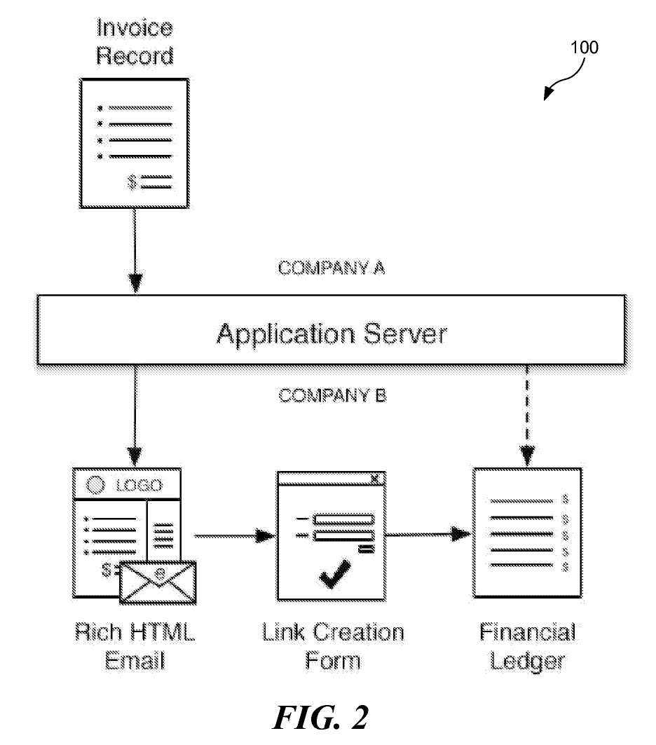

FIG. 2 illustrates that once a vendor creates a first invoice for a particular customer, the system 100 may then send the customer an e-mail message (e.g., a rich HTML e-mail message) containing an URL for a link creation form. By clicking the link creation URL, the customer causes the system 100 to add the invoice to the customer's ledger. Thereafter, the system 100 automatically adds, deletes, and modifies invoices (and the ledger) in response to the vendor's invoicing activities. Of course, the system 100 may also be configured such that a customer may modify the ledger thereby causing the system 100 to change the corresponding information in the database.

In the embodiment illustrated in FIG. 2, invoices sent as rich HTML e-mail contain a URL back to the service, where the client may either log in or create an account with the service. The invoice data is then added to the client's financial ledger, forming a link between the vendor's account and the client's account. With that link established, all future invoices from the vendor will automatically be added to the client's financial ledger. Company A creates an invoice record for Company B with the service. Company B receives a rich HTML e-mail, which includes a URL to the link creation form. Once Company B links the invoice to his account, it is added to his financial ledger. Once the link has been created, future invoices from Company A are automatically added to Company B's financial ledger.

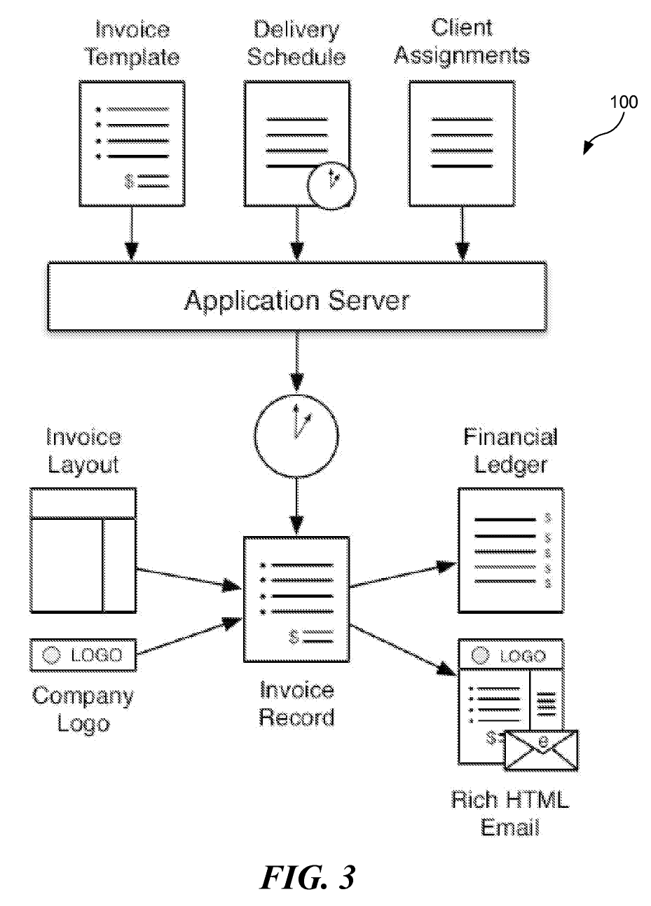

FIG. 3 also shows that the creation of invoices may be automated particularly for periodic invoicing. In the embodiment illustrated in FIG. 3, users define invoice templates, which contain line item descriptions, quantities, and payment terms-but no client information. Then, the template is assigned to one or more clients, each with a delivery schedule (e.g., monthly, yearly, every N days, etc.). The service automatically creates new invoice records at the appropriate time, adds the record to the financial ledger, and merges the data with an invoice layout and company logo, and delivers the invoice to the client as a rich HTML e-mail. The user defines an invoice template with line items, payment terms, etc. The template may be assigned to any number of clients, along with a delivery schedule (monthly, weekly, etc.). The service automatically creates new invoice records for each template, for each client, on the given schedule. A newly created invoice record is automatically added to the user's financial ledger, merged with an invoice layout and company logo, and sent to the client as a rich HTML e-mail.

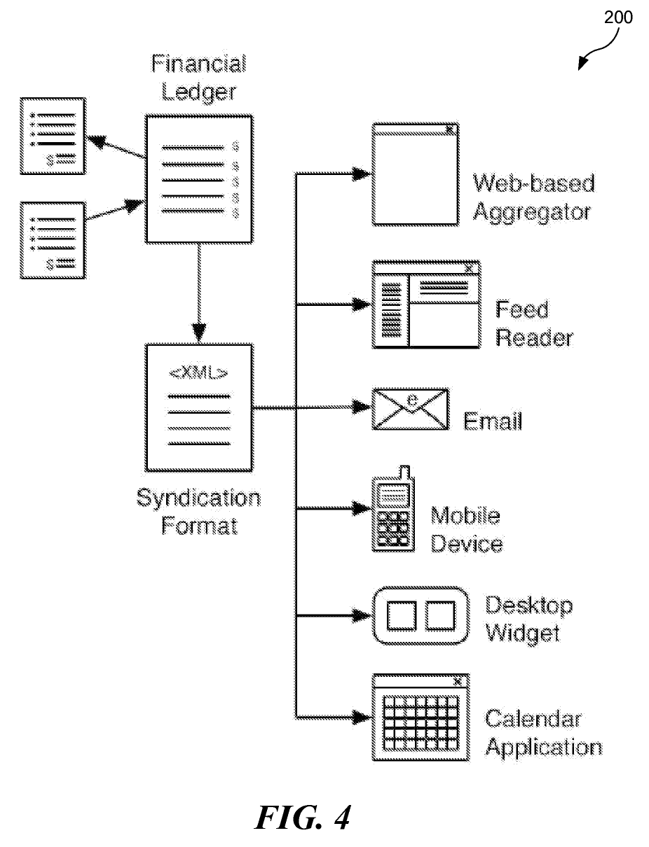

In addition to the automatic creation of invoices as shown by FIG. 4, a system 200 constructed in accordance with an embodiment of the present invention may be configured to send the invoices using RSS or other publication or syndication methods. For example, the invoices may be distributed in the iCalender format so that a user enjoys enhanced flexibility in the types of devices (e.g. a cell phone or a calendar application) with which the user can access information in the system 100.

In the embodiment illustrated in FIG. 4, invoice data on a financial ledger is automatically available in various syndication formats, allowing data to be integrated into third-party or custom applications. Specifically, invoice records are published in RSS and Atom formats, enabling a host of devices to aggregate and display the data, and automatically inform the user of updates. Data from the financial ledger is also automatically made available in the iCalendar format, so that invoice events (such as due dates) can be integrated into third-party calendar management applications. The financial ledger manages and displays invoices according to date, status, client, amount, and metadata tags. All data on the financial ledger can be exported in XML formats (e.g., RSS an Atom), to be consumed by third-party tools. Third party devices and software display changes in the financial ledger, such as new invoice comments.

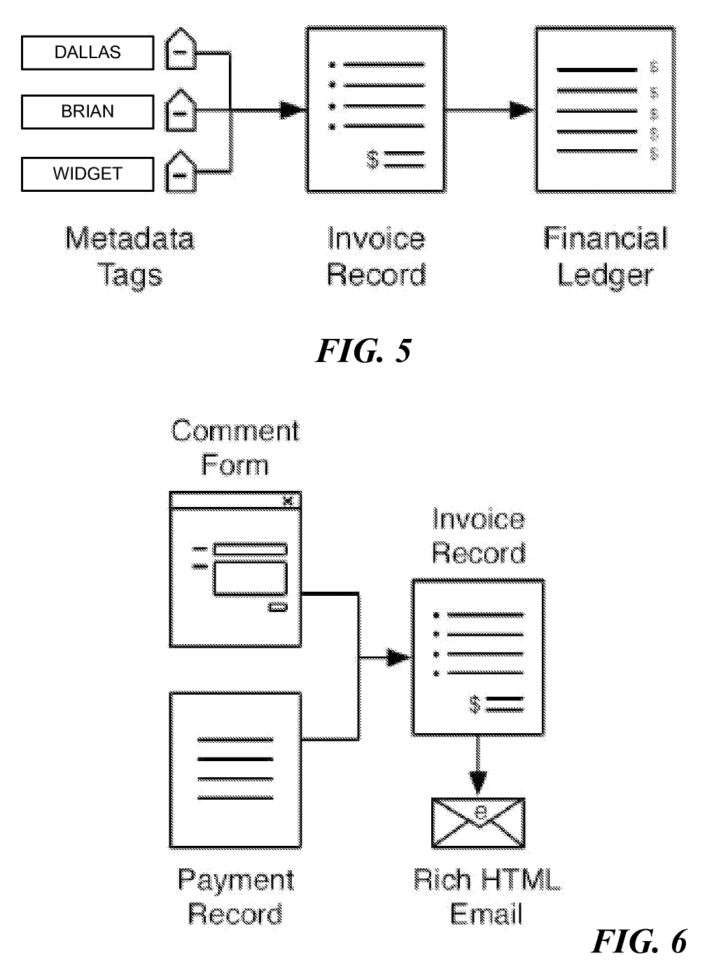

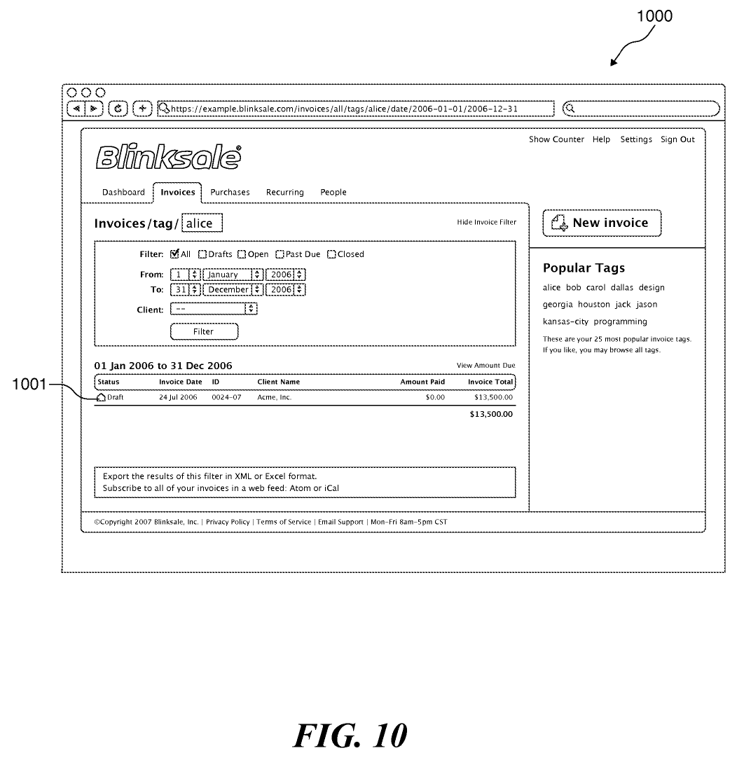

FIG. 5 illustrates that a user may create metadata tags for the invoices in the system 100. These tags allow the user to filter the database in the server to, for example, find invoices meeting user specified criteria. The metadata tags may be included in the e-mail messages described previously and further illustrated with reference to exemplary FIGS. 10-15.

In the embodiment illustrated in FIG. 5, users may assign metadata tags to invoices-strings of text used to annotate or identify arbitrary properties of an invoice, such as product category, office location, salesperson, etc. After an invoice has been sent and linked to a client account, the client may also add metadata tags to the invoice. From their financial ledger, both vendor and client may sort, filter, export, and report on invoices by tags, tag union, tag intersection, or tag disjunction. For example, a user could request all invoices tagged “foo” or “bar” and “baz” but not “quux”. Via a web form, a user adds metadata tags to an invoice record. The financial ledger may then be sorted and filtered based on tags and tag combinations.

FIG. 6 shows that a user (e.g. the vendor) can associate comments with the invoices in the system 100. If the user chooses to do so, these comments can be forwarded to other users (e.g., the customer) via an e-mail message. Additionally, comments may be associated with an invoice when certain events (e.g., delivery of invoice or the recording of a payment) occur.

In the embodiment illustrated in FIG. 6, after an invoice is created, users may use a web form to add free-form textual comments to the invoice record. Comments are displayed in chronological order, along with the time, date, and creator. New comments can be automatically e-mailed to contacts. Comments can be created and viewed by the client as well as the vendor, allowing for secure, private, logged discussion and dispute resolution related to an invoice. System comments are automatically created to log certain events, such as delivering of a rich HTML e-mail and recording a payment. Via a web form, a user adds a comment to an invoice record. When the user creates a payment record for the invoice, a system comment is logged. Comments can automatically be sent via e-mail to client contacts.

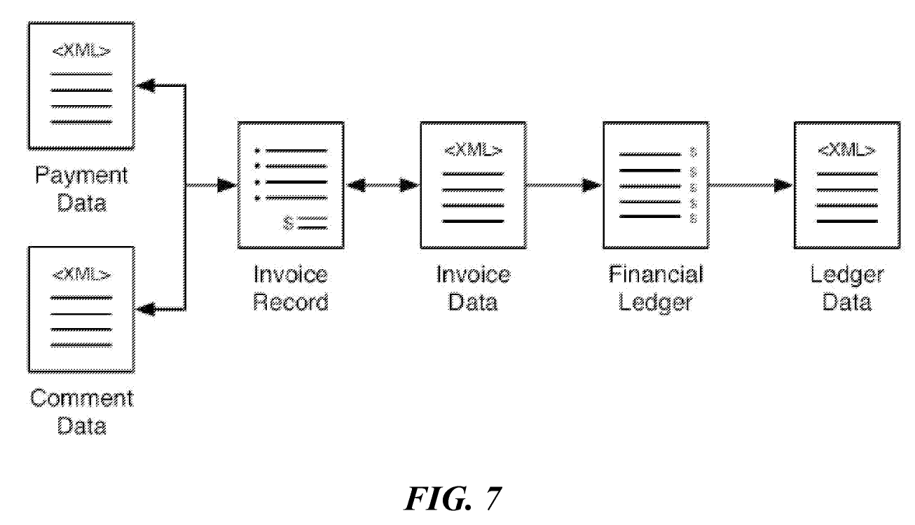

FIG. 7 illustrates that an API (Application Program Interface) for the system 100 may use XML in the creation, deletion, modification and distribution of invoices using the system 100. In the embodiment illustrated in FIG. 7, the service provides a platform- and language-neutral Application Programming Interface (API) to access data from the financial ledger from third-party of custom applications. By means of the XML format at the HTIP protocol, invoice records can be created, updated, and deleted; payment and comment records may be added to invoices, summary data can be read from the financial ledger, and client records may be added, updated, or deleted. Invoice, payment, and comment records can be read, updated, and created. Summary data can be accessed through the financial ledger.

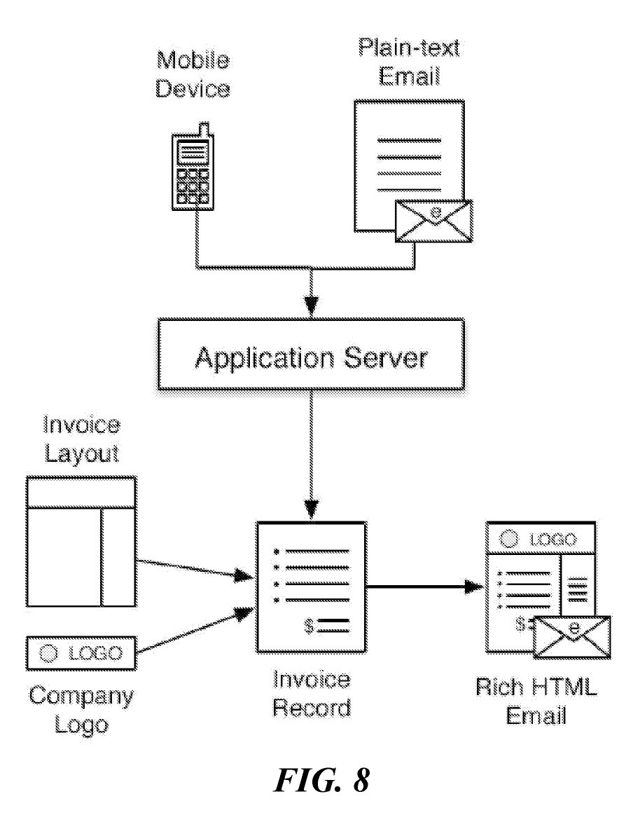

Similarly, FIG. 8 shows that the system 100 may convert plain text e-mail messages (or even message in other formats such as the Short Message Service format) to the format of the other invoices in the system 100. In the embodiment illustrated in FIG. 8, users of the service may use mobile devices or plain email to create and deliver invoices without access to a web browser. Users are assigned an email address where the service can receive plain-text messages. The service parses the message to extract invoice data, creating a new invoice record, accessible from the user's financial ledger. The record can then be merged with an invoice layout and company logo, and sent to the client as a rich HTML e-mail. Users may send invoice data to the service via plain text e-mail or Short Message Service (SMS) from a mobile device. The service automatically converts the unstructured text data into an invoice record, merges the record with an invoice layout and company logo, and delivers a rich HTML e-mail.

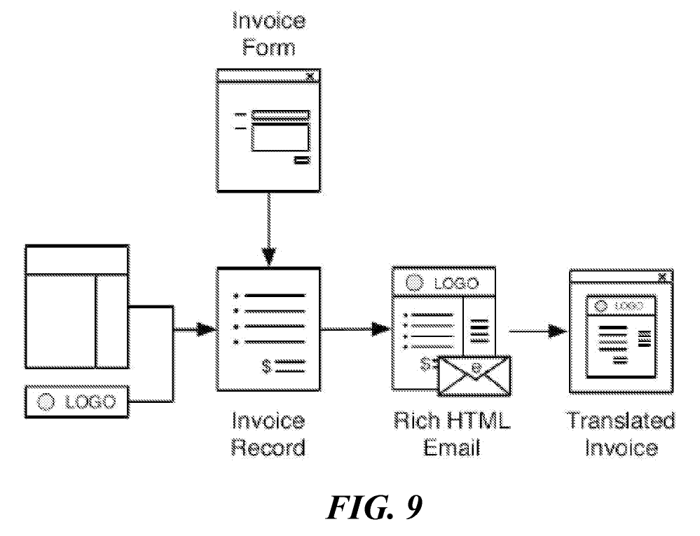

Further, FIG. 9 shows that the system 100 may be configured to translate invoices created in one language to another language (e.g, English to Spanish or vice versa). In the embodiment illustrated in FIG. 9, the service enables users to create invoices in their language, and automatically translate portions of the invoice into the native language of the client. Most invoice data (with the exception of line item descriptions) is automatically translated into supported languages, easing communication between parties. Company A creates an invoice in the user's native language (e.g. English). Data includes descriptions, quantities, prices, tax, freight, payment terms, and currency. Company B receives a rich HTML e-mail including a URL for the invoice, and opens the URL in a browser. The invoice is displayed in the user's native language-translated data includes quantities, prices, tax, freight, payment terms, and currency.

Now with reference to FIGS. 10 to 15, screenshots 1000, 1100, 1200, 1300, 1400 and 1500 of exemplary ledgers are illustrated. In FIGS. 10-15 a user has created three exemplary invoices and has added exemplary tags to each. That is, Invoice #1001 is tagged with “alice” (the account rep), “dallas” (the branch office), and “design” (the service provided). Similarly Invoice #1002 is tagged with “bob”, “houston”, and “programming.” Invoice #1003 is tagged with “carol”, “kansascity”, and “programming.”

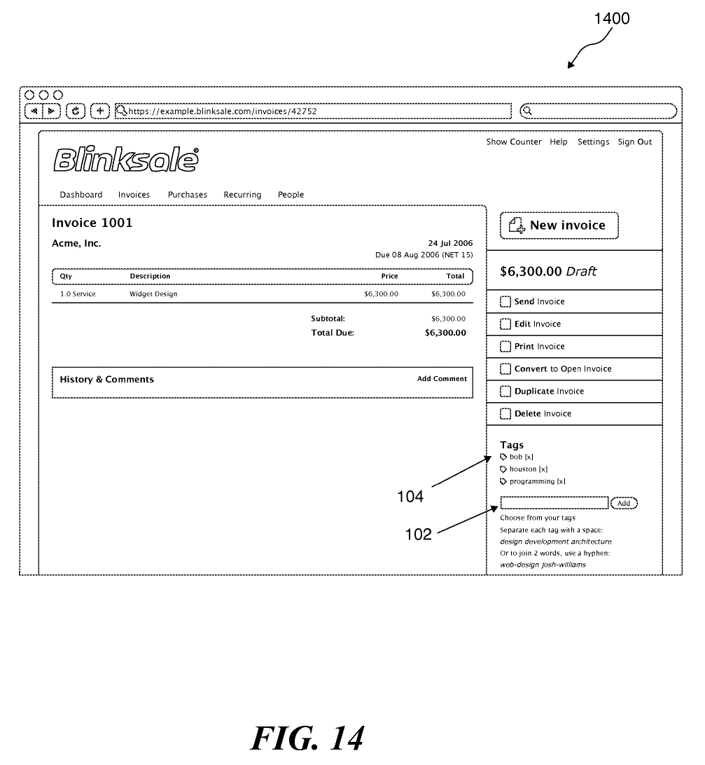

FIG. 14 shows, in the lower-right corner, an exemplary interface 102 for adding and deleting tags. The “tag cloud” 104 on the right shows the tags in the system. In one embodiment of the present invention, the tags in the tag cloud 104 can be roughly scaled according to the invoice dollar-amount associated with each one (or other user selectable criteria) so that for instance, the sales person or customer with the highest volume can be identified.

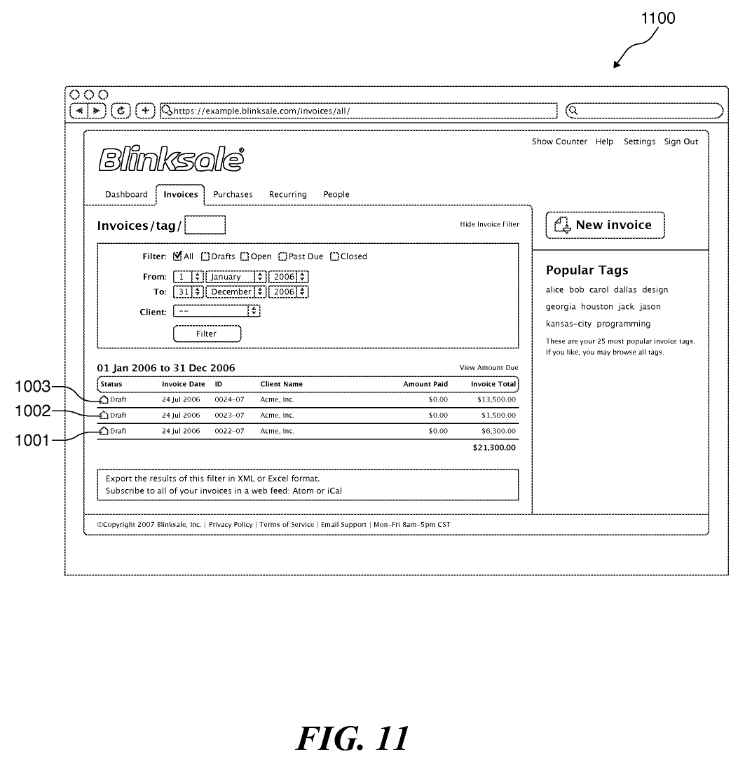

Thus, when viewing the Financial Ledger, the user may slice up the data to create ad-hoc reports. For example, the user might want to view all invoices and filter the data to create the filtered ledger shown in FIG. 11. The corresponding URL used for the filter may thus be:

http://example.blinksale.com/invoices/all

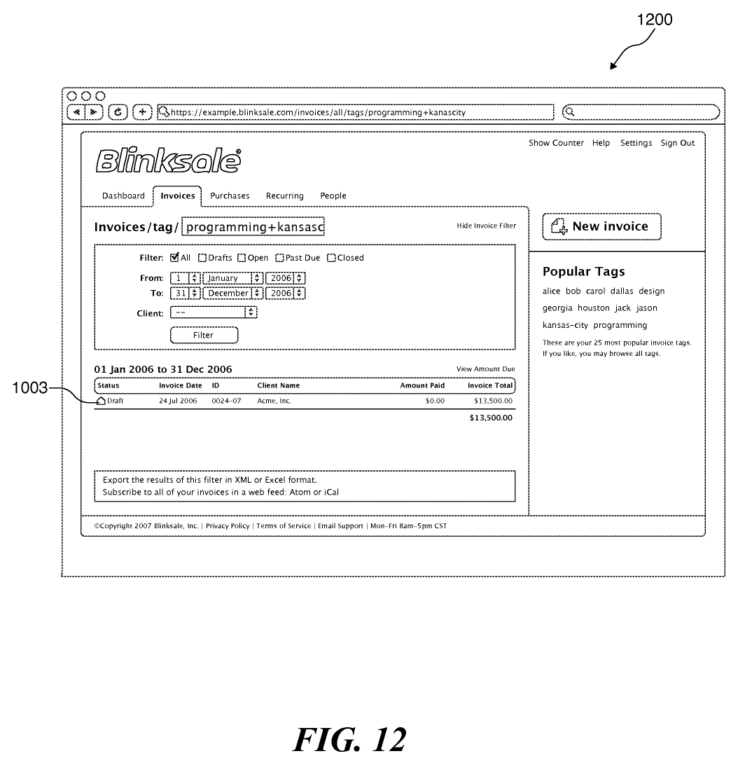

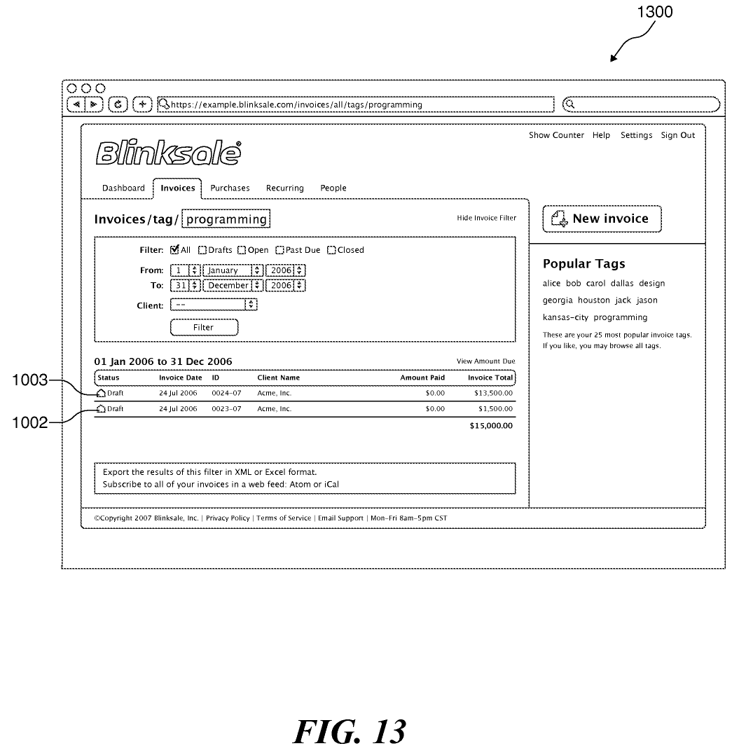

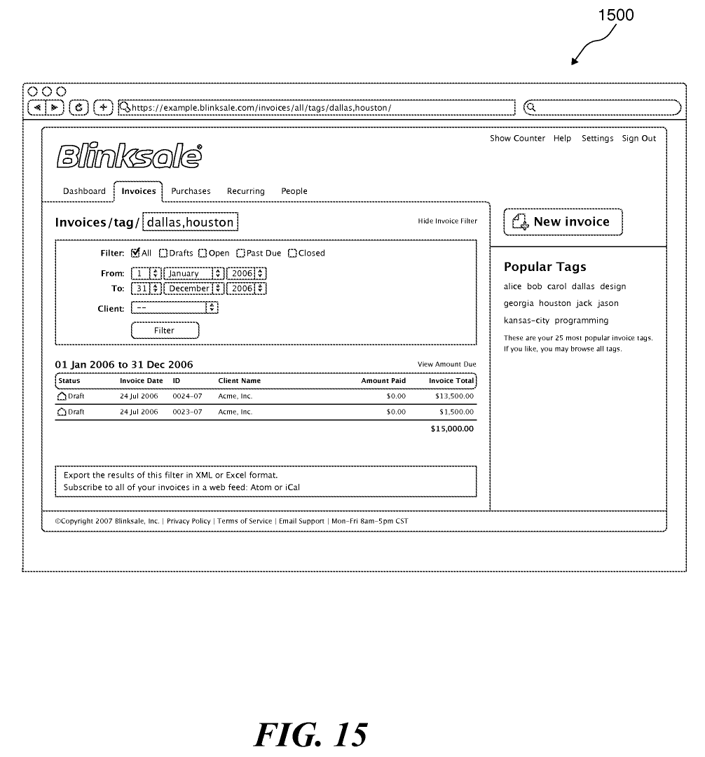

Thus, FIG. 11 shows an exemplary invoice ledger with all three invoices. FIG. 10 and FIG. 13 each show the ledger filtered by one tag (“Alice” and “programming” respectively). FIG. 12 and FIG. 15 shows that tags can be logically combined in at least two ways (intersection or union respectively) to filter the ledger.

The user may also wish to view all invoices from a particular representative (e.g., Alice). The corresponding URL that filters for “Alice” (or Invoice 1001) may be as is shown in FIG. 10:

http://example.blinksale.com/invoices/all/tags/alice

In the alternative, the user may wish to view all invoices for a certain type of service. As shown by FIG. 13, the corresponding URL to filter for “programming” may thus be:

http://example.blinksale.com/invoices/all/tags/programming

For another example, the user may wish to view all invoices from a region that might include cities identified by different tags. In which case, as shown in FIG. 15, a tag union (i.e., a logical “or”) is used in the URL as shown here to display Invoices 1001 and 1002:

http://example.blinksale.com/invoices/all/tags/dallas,houston/

Or the user may wish to view all invoices with a combination of tags (using an intersection or a logical “and”). In which case FIG. 12 shows an exemplary URL:

http://example.blinksale.com/invoices/all/tags/programming+kansascity

It is understood that the present invention can take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method of managing a financial transaction, the method comprising:
receiving input data from a vendor system;
generating a first financial transaction document by merging the input data with customer data and layout data;
generating content for a second financial transaction document from the input data; and
electronically mailing the first document to a customer.

2. The method of claim 1 wherein receiving input data comprises receiving at least one selected from the list consisting of:
a plain text e-mail, a short message service (SMS) message and an application programming interface (API) request.

3. The method of claim 1 wherein generating a first financial transaction document further comprises merging the input data with a vendor logo and a greeting.

4. The method of claim 1 wherein generating a first financial transaction document comprises generating an invoice.

5. The method of claim 1 wherein generating a first financial transaction document comprises generating a hypertext markup language (HTML) document.

6. The method of claim 1 wherein generating content for a second financial transaction document comprises adding information to a financial ledger.

7. The method of claim 1 further comprising:
creating a link in a database relating the first document to the second document.

8. The method of claim 1 further comprising:
receiving input from the customer; and
modifying the second document based on the customer input.

9. The method of claim 1 further comprising:
annotating the first document.

10. The method of claim 1 further comprising:
recording payment information in at least one of the first document and the second document.

11. The method of claim 1 further comprising:
scheduling a delivery for electronically mailing the first document based on a vendor-specified period, wherein electronically mailing the first document comprises electronically mailing the first document according to the delivery schedule.

12. The method of claim 1 further comprising:
automatically adding late fees in at least one of the first document and the second document.

13. The method of claim 1 further comprising:
translating at least a portion of the first document into a language different than a language of the input data.

14. The method of claim 1 further comprising:
publishing at least one of the first document and the second document in a syndication format.

15. The method of claim 1 further comprising:
enabling modification of at least one of the first document and the second document using an application program interface (API).

16. A computer program embodied on a computer readable medium, the program comprising:
code for receiving input data from a vendor system;
code for generating a first financial transaction document by merging the input data with customer data and layout data;
code for generating content for a second financial transaction document from the input data; and
code for electronically mailing the first document to a customer.

17. The program of claim 16 further comprising:
code for converting a plain text e-mail and a short message service (SMS) message to a format of the first document.

18. The program of claim 16 further comprising:
code for adding a vendor logo and a greeting to the first document.

19. The program of claim 16 wherein the first document comprises an invoice.

20. The program of claim 16 wherein the code for generating a first financial transaction document comprises code for generating a hypertext markup language (HTML) document.

21. The program of claim 16 wherein the second document comprises a financial ledger.

22. The program of claim 16 further comprising:
code for creating a link in a database relating the first document to the second document.

23. The program of claim 16 further comprising:
code for receiving input from the customer; and
code for modifying the second document based on the customer input.

24. The program of claim 16 further comprising:
code for annotating the first document.

25. The program of claim 16 further comprising:
code for recording payment information in at least one of the first document and the second document.

26. The program of claim 16 further comprising:
code for scheduling a delivery for electronically mailing the first document based on a vendor-specified period, wherein electronically mailing the first document comprises electronically mailing the first document according to the delivery schedule.

27. The program of claim 16 further comprising:
code for automatically adding late fees in at least one of the first document and the second document.

28. The program of claim 16 further comprising:
code for translating at least a portion of the first document into a language different than a language of the input data.

29. The program of claim 16 further comprising:
code for publishing at least one of the first document and the second document in a syndication format.

30. The program of claim 16 further comprising:
code for enabling modification of at least one of the first document and the second document using an application program interface (API).

31. A system for managing a financial transaction, the system comprising:
an application server configured to:
receive input data from a vendor system;
generate a first financial transaction document by merging the input data with customer data and layout data;
generate content for a second financial transaction document from the input data; and
electronically mail the first document to a customer.

32. The system of claim 31 wherein the application server is further configured to convert a plain text e-mail and a short message service (SMS) message to a format of the first document.

33. The system of claim 31 wherein the application server is further configured to add a vendor logo and a greeting to the first document.

34. The system of claim 31 wherein the first document comprises an invoice.

35. The system of claim 31 wherein the first document comprises a hypertext markup language (HTML) document.

36. The system of claim 31 wherein the second document comprises a financial ledger.

37. The system of claim 31 wherein the application server is further configured to create a link in a database relating the first document to the second document.

38. The system of claim 31 wherein the application server is further configured to:
receive input from the customer; and
modify the second document based on the customer input.

39. The system of claim 31 wherein the application server is further configured to record payment information in at least one of the first document and the second document.

40. The system of claim 31 wherein the application server is further configured to electronically mail the first document according to a delivery schedule.

41. The system of claim 31 wherein the application server is further configured to automatically add late fees in at least one of the first document and the second document.

42. The system of claim 31 wherein the application server is further configured to translate at least a portion of the first document into a language different than a language of the input data.

43. The system of claim 31 wherein the application server is further configured to publish at least one of the first document and the second document in a syndication format.

44. The system of claim 31 wherein the application server is further configured to enable modification of at least one of the first document and the second document using an application program interface (API).
